(19) United States
(12) Patent Application Publication
(10) Pub. No.: US 2014/0282956 A1
(43) Pub. Date: Sep. 18, 2014

(54) SYSTEM AND METHOD FOR USER AUTHENTICATION

(71) Applicant: SONY CORPORATION, Tokyo (JP)

(72) Inventors: Sean Kennedy, San Diego, CA (US); Edward Winter, San Diego, CA (US)

(73) Assignee: SONY CORPORATION, Tokyo (JP)

(21) Appl. No.: 13/795,939

(22) Filed: Mar. 12, 2013

(51) Int. Cl. H04L 29/06

(52) U.S. Cl. CPC H04L 63/08
USPC 726/7

(57) ABSTRACT

Various aspects of a system and method for user authentication are disclosed herein. An audio input is received from one of a plurality of computing devices associated with a user. The user identification data associated with the user based on said received audio input is determined. An association of the user with one or more other users in a social network is determined based on comparison of the determined user identification data with pre-stored user identification data. The user is authenticated to participate in an event in association with the one or more other users based on the comparison.

### CROSS-REFERENCE TO RELATED APPLICATIONS/INCORPORATION BY REFERENCE

None.

### FIELD

Various embodiments of the disclosure relate to user authentication. More specifically, various embodiments of the disclosure relate to user authentication in a social network.

### BACKGROUND

Recent developments in user authentication techniques have seen a move towards addition of multiple security layers, for example facial recognition, to an audio input to enable access to a restricted device, an event, a restricted file or information, and the like. However, existing authentication techniques that implement a combination of audio input and other security layers may be vulnerable to malicious access.

Further limitations and disadvantages of conventional and traditional approaches will become apparent to one of skill in the art, through comparison of described systems with some aspects of the present disclosure, as set forth in the remainder of the present application, with reference to the drawings.

### SUMMARY

A system and method are provided for user authentication substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for user authentication, in accordance with an embodiment of the disclosure.

FIG. 2 is a block diagram illustrating an authentication server for user authentication, in accordance with an embodiment of the disclosure.

FIG. 3 is a block diagram illustrating a computing device for user authentication, in accordance with an embodiment of the disclosure.

FIG. 4 is a flowchart illustrating a method for user authentication, in accordance with an embodiment of the disclosure.

FIG. 5 is a flowchart illustrating another method for user authentication, in accordance with an embodiment of the disclosure.

FIG. 6 is a flowchart illustrating another method for user authentication, in accordance with an embodiment of the disclosure.

### DETAILED DESCRIPTION

The following described implementations may be found in a system and/or method for user authentication.

Exemplary aspects of the disclosure may include a method for user authentication. The method may include determining one or more rules for participating in an event. The one or more rules may define an association between a first user and one or more other users participating in the event. The method may include receiving an audio input from a second user. The method may include determining user identification data associated with the second user based on the received audio input. The method may include determining whether the second user is associated with the first user based on comparison of the determined user identification data with pre-stored user identification data. The method may include authenticating the second user to participate in the event based on the comparison and the one or more rules.

In an embodiment, the method may include communicating an invite to the one or more other users participating in the event. The one or more rules may include one or more pre-specified passphrases, a master set of tones, a threshold associated with the comparison of the determined user identification data with pre-stored user identification data.

In an embodiment, the association of the first user with the one or more other users in the social network is based on one or more parameters. The one or more parameters may comprise an area of interest, an activity of interest, an event, an educational background, a professional background, a relation, or a social network connection.

Exemplary aspects of the disclosure may include a method for user authentication. The method may include receiving an audio input from one of a plurality of computing devices associated with a user. The method may include determining user identification data associated with the user based on the received audio input. The method may include determining whether the user is associated with one or more other users in a communication network based on comparison of the determined user identification data with pre-stored user identification data. The method may include authenticating the user to participate in an event in association with the one or more other users based on the comparison.

In an embodiment, the authentication server may determine a passphrase from the received audio input based on one or more voice recognition algorithms or one or more speech-to-text conversion software applications.

In an embodiment, the method may include comparing the determined passphrase with one or more pre-specified passphrases. In an embodiment, the one or more pre-specified passphrases may be determined by the user. In an embodiment, the one or more pre-specified passphrases may be determined by the one or more other users. The method may include authenticating the user based on the comparison of the determined passphrase with the one or more pre-specified passphrases. In an embodiment, the one or more pre-specified passphrases are same for the user and the one or more other users. In an embodiment, the one or more pre-specified passphrases are different for the user and the one or more other users.

In an embodiment, the received audio input may include a set of tones. The set of tones may be generated by a multimedia application associated with one of the plurality of computing devices. In an embodiment, the received set of tones may be compared with a master set of tones. In an embodiment, the master set of tones may be defined by the user or the one or more other users.

In an embodiment, the user identification data may include a user profile of the user associated with the one of the plurality of computing devices. In an embodiment, the user profile associated with the user may include a geographical location of the user, a facial image of the user or demographic details of the user. In an embodiment, the pre-stored user identification data may include one or more user profiles associated with the user and the one or more other users.

In an embodiment, the event may include communication of the user with the one or more other users, accessing an online event, accessing online or offline information, joining an online conference, sharing or receiving an electronic file or accessing a restricted application. In an embodiment, the online event may include a meeting, a conference, a multi-player game, a video session or a chat session in the social network.

In an embodiment, the association of the user with the one or more other users in the social network may be based on one or more parameters between the user and the one or more other users. In an embodiment, the one or more parameters between the user and the one or more other users may include one or more of an area of interest, an activity of interest, an event, an educational background, a professional background, a relation, or a social network connection.

Exemplary aspects of the disclosure may include a method for user authentication in a social network. In an embodiment, the method may include receiving an audio input from a user. The method may include determining user identification data associated with the user based on the received audio input. The method may include determining whether the user is associated with one or more other users in the communication network based on comparison of the determined user identification data with pre-stored user identification data. The method may include authenticating the user to participate in an event in association with the one or more other users based on the comparison.

In an embodiment, the method may include personalizing a login screen of one of the plurality of computing devices by the user based on the authentication. In an embodiment, the method may include changing a user interface of one of the plurality of computing devices by the user based on the authentication.

FIG. 1 is a block diagram illustrating a network environment, in accordance with an embodiment of the disclosure. With reference to FIG. 1, there is shown a network environment 100. The network environment 100 may include an authentication server 102, a database 104, a social networking server 106, and a communication network 110. The communication network 110 may include a social network 114. The network environment 100 may include a plurality of computing devices 108a, 108b and 108c (collectively referred to as a computing device 108), and a plurality of users 112a, 112b and 112c (collectively referred to as a user 112). The user 112a is associated with the computing device 108a, the user 112b is associated with the computing device 108b, and the user 112c is associated with the computing device 108c. Although FIG. 1 shows only three computing devices (such as the computing devices 108a, 108b and 108c) and only three users (such as the user 112a, the user 112b, and user 112c) for simplicity, one skilled in the art may appreciate that the implementation of disclosed embodiments can occur for a larger number of computing devices and associated users in the social network 114.

The authentication server 102, the social networking server 106, and the computing device 108 may be operable to communicate with each other via the communication network 110. The authentication server 102, the social networking server 106, and the computing device 108 may be operable to connect to the communication network 110, in accordance with various wired and wireless communication protocols, such as Transmission Control Protocol and Internet Protocol (TCP/IP), User Datagram Protocol (UDP), Hypertext Transfer Protocol (HTTP), or File Transfer Protocol (FTP). Examples of the communication network 110 may include, but are not limited to, the Internet, a Wireless Fidelity (Wi-Fi) network, a Wireless Area Network (WAN), a Local Area Network (LAN), or a Metropolitan Area Network (MAN).

The authentication server 102 may comprise suitable logic, circuitry, interfaces, and/or code that may be accessed by the computing device 108, either directly or via the communication network 110. The authentication server 102 may be operable to access the database 104, either directly or via the communication network 110. In an embodiment, the authentication server 102 may be implemented as part of a server cloud. In an embodiment, the authentication server 102 may be accessed and managed by a third party. In an embodiment, the authentication server 102 may be configured to manage a user account and a friend database in the database 104 for the user 112 of the network environment 100. The authentication server 102 is described below in further detail, in conjunction with FIG. 2.

The database 104 may comprise suitable logic, circuitry, interfaces, and/or code that may be operable to store a repository that may include one or more pre-specified passphrases and/or a master set of tones for each end user of the network environment 100. In an embodiment, the database 104 may be communicably coupled to the authentication server 102 through the communication network 110. In an embodiment, the database 104 may be communicably coupled to the authentication server 102 through the communication network 110. The database 104 may communicate with the computing device 108 through the authentication server 102 in the network environment 100. The database 104 may be implemented by using various database software applications that are well known to those skilled in the art. Some examples of database software applications may include, but are not limited to, MySQL® and Microsoft SQL®.

The social networking server 106 may comprise suitable logic, circuitry, interfaces, and/or code that may be operable to host one or more social networking websites, such as servers of Facebook®, Google+®, and/or MySpace®. Notwithstanding, the disclosure may not be so limited and other social networking websites may be hosted without limiting the scope of the disclosure. The user 112 may connect with other users in the network environment 100 via the social networking website. Based on the user identification data of the user 112, the social network 114 of the user 112 is formed. Thus, based on the user identification data of the user 112, the social network 114 of the user 112 may include other users that connect to the user 112 through the social networking website. The social networking server 106 may provide the user identification data of the user 112 associated with the hosted social networking website. Examples of such user identification data may include, but are not limited to a user profile of the user 112, user profiles of the other users forming the social network 114 of the user 112, a friend list of the user 112, an update associated with the social network 114 of the user 112, information about social gatherings, and information (such as an image, a comment, and the like) posted by the user 112 and/or the other users on the social networking website.

In an embodiment, the authentication server 102 and the social networking server 106 may be cloud based servers. In an embodiment, the social networking server 106 may store user identification data for the user 112. In an embodiment, the user identification data may include a user profile of the user 112, user profiles of the one or more other users forming the social network 114 of the user 112, an update associated with the social network 114 of the user 112, information about social gatherings, information posted by the user 112 and the other users on the social networking website, and the like. In an embodiment, the user profile associated with the user may include a geographical location of the user 112, a facial image of the user 112 or demographic details of the user 112. The user identification data may also include news feeds, the latest news related to a local area, event information from a local news website, reviews about food, restaurants, books, movies, people, products, and events, current and/or forecasted weather information about an area, information about local deals in an area, places of interest in an area, and advertisements related to local products, and the like.

The computing device 108 may include suitable logic, circuitry, interfaces, and/or code that may be operable to receive the audio input from the user 112. Examples of the computing device 108 may include, but are not limited to, laptops, tablet computers, smart phones, and Personal Digital Assistant (PDA) devices. In an embodiment, the computing device 108 may include a web browser application that enables the user 112 to access, retrieve, and view web pages on the Internet. In an embodiment, the computing device 108 may include a social networking application through which the user 112 may communicate with the social networking server 106. In an embodiment, the user 112 may use the computing device 108 to browse the one or more web pages of the social networking website and/or any other website. For example, through the computing device 108, the user 112 may perform various activities, such as post comments on the social networking website, view images uploaded by other users on the social networking website, and read reviews about products and/or services.

In an embodiment, the computing device 108 may include a Global Positioning System (GPS) sensor that determines the geo-location of the computing device 108. The geo-location of the computing device 108 may correspond to the geo-location of the user 112 associated with the computing device 108. The user 112 may install a software application 116 (not shown in FIG. 1) on the computing device 108. The software application 116 may enable the computing device 108 to use the social networking website. Examples of the software application 116 include, but are not limited to, Internet Explorer®, Mozilla Firefox® and the like. Thus the software application 116 may facilitate the user 112 to connect with other users in the network environment 100 through the social networking website. The computing device 108 is described below in further detail, in conjunction with FIG. 3.

The communication network 110 may include a medium through which the computing device 108 may communicate with the authentication server 102, the social networking server 106, and in the network environment 100. Examples of the communication network 110 may include, but are not limited to, the Internet, a Wireless Fidelity (WiFi) network, a Wireless Local Area Network (WLAN), a Local Area Network (LAN), a telephone line (POTS), or a Metropolitan Area Network (MAN). Various devices in the network environment 100 may be operable to connect to the communication network 110, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR). IEEE 802.11, 802.16, cellular communication protocols, and/or Bluetooth (BT) communication protocols.

The social network 114 may include suitable logic, circuitry, interfaces, and/or code that may be operable to provide an online platform to facilitate social relationships among the user 112a and one or more other users, for example the user 112b. An association of the user 112a with the user 112b in the social network 114 is based on one or more parameters between the user 112a and the user 112b. Examples of the one or more parameters may include, but are not limited to, an area of interest, an activity of interest, an event, an educational background, a professional background, a relation, or a social network connection. Notwithstanding, the disclosure may not be so limited, and other parameters may be utilized without limiting the scope of the disclosure.

In operation, the authentication server 102 may determine one or more rules for participating in an event. The one or more rules may define an association between the user 112b and the user 112a participating in the event. The one or more rules may include one or more pre-specified passphrases, a master set of tones, a threshold associated with the comparison of user identification data of the user 112a with pre-stored user identification data. In an embodiment, the authentication server 102 may communicate an invite to the user 112a participating in the event.

The authentication server 102 may receive an audio input from the computing device 108a. In response to the audio input, the authentication server 102 may determine user identification data associated with the user 112a based on the received audio input. The user identification data may include a user profile of the user associated with the computing device. The user profile associated with the user may include one or more of a geographical location of the user, a facial image of the user or other demographic details of the user.

In an embodiment, the computing device 108a may determine a passphrase from the received audio input. The authentication server 102 may determine the passphrase by applying one or more voice recognition algorithms to the received audio input. In an embodiment, the one or more voice recognition algorithms may include one or more statistical models to extrapolate speech patterns from the audio input. The one or more statistical models may be based on acoustic and/or language modeling of the speech patterns of the received audio input. For example, a passphrase spoken by the user 112 for logging into an application in the computing device 108a may be “beautiful day”. The passphrase “beautiful day” may be pronounced differently by the user 112 depending on regional dialects, for example, North-Eastern and Southern dialect of American English. The one or more statistical models identify the spoken passphrase “beautiful day” based on extrapolation of the speech pattern of the spoken passphrase.

Some examples of one or more voice recognition algorithms may include, but are not limited to, Frequency Estimation Algorithms, Hidden Markov Models, Gaussian Mixture Models, Pattern Matching Algorithms, Neural Networks, Matrix Representation, Vector Quantization Algorithms, Decision Trees, and Dynamic time warping (DTW)-based speech recognition. Notwithstanding, the disclosure may not be so limited, and other voice recognition algorithms may be utilized without limiting the scope of the disclosure.

Some examples of one or more speech-to-text conversion software applications may include, but are not limited to, Vlingo© and Dragon©. Notwithstanding, the disclosure may not be so limited, and other speech-to-text conversion software applications may be utilized without limiting the scope of the disclosure.

in an embodiment, the passphrase may include a predetermined sequence of words spoken by the user 112a. The predetermined sequence of spoken words may include random length and tonal frequencies. The random length and the tonal frequencies of the predetermined sequence of spoken words comply with hardware limitations of the computing device 108a.

in an embodiment, the authentication server 102 further determines the set of tones from the audio input. In an embodiment, the computing device 108a determines the set of tones from the audio input.

In an embodiment, the set of tones may be generated manually by the user 112a of the computing device 108a. In an embodiment, the set of tones may be automatically generated by a multimedia application associated with the computing device 108a.

In an embodiment, the passphrase and/or the set of tones may be determined by the user 112a or the user 112b. In an embodiment, the passphrase and/or the set of tones may be same for the user 112a or the user 112b. In an embodiment, the passphrase and/or the set of tones may be different for the user 112a or the user 112b.

In an embodiment, the authentication server 102 may compare the passphrase and/or the set of tones determined from the received audio input, with one or more pre-specified passphrases and/or a master set of tones pre-stored in the repository. In an embodiment, the database 104 may store the repository that includes the one or more pre-specified passphrases and/or the master set of tones. In an embodiment, the memory 204 of authentication server 102 may store the repository that includes the one or more pre-specified passphrases and/or the master set of tones. In an embodiment, the memory 304 of the computing device 108a may store the repository that includes the one or more pre-specified passphrases and/or the master set of tones.

In an embodiment, the computing device 108a may compare the passphrase and/or the set of tones determined from the received audio input, with one or more pre-specified passphrases and/or a master set of tones pre-stored in the repository.

In instances, where the passphrase and/or the set of tones does not match the one or more pre-specified passphrases and/or the master set of tones in the repository, the user 112a will be denied access to the computing device 108a. Accordingly, the user 112a may be unable to participate in the event in association with the user 112b. In instances where the passphrase and/or the set of tones successfully matches the one or more pre-specified passphrases and/or the master set of tones in the repository, the authentication server 102 may determine the user identification data associated with the user 112a based on the received audio input. The authentication server 102 may determine whether the user 112a is associated with one or more other users, for example the user 112b, in the social network 114. The authentication server 102 may determine the association of the user 112a with the user 112b based on comparison of the determined user identification data with the pre-stored user identification data. In an embodiment, the authentication server 102 may determine the association of the user 112a with the user 112b based on the one or more rules. In an embodiment, the authentication server 102 may not determine an association of the user 112a with one or more users, for example, the user 112c based on comparison of the determined user identification data with the pre-stored user identification data. In an embodiment, the pre-stored user identification data may be stored in the social networking server 106.

In an embodiment, the computing device 108a may determine the user identification data associated with the user 112a based on the received audio input. The computing device 108a may determine whether the user 112a is associated with one or more other users, for example, the user 112b, in the social network 114. The computing device 108a may determine the association of the user 112a with the user 112b based on comparison of the determined user identification data with the pre-stored user identification data. In an embodiment, the computing device 108a may not determine an association of the user 112a with one or more users, for example, the user 112c based on comparison of the determined user identification data with the pre-stored user identification data.

In an embodiment, the authentication server 102 may receive a verification from the social networking server 106 as to whether the user 112a is associated with the user 112b in the social network 114 based on the user identification data of the user 112a. The social networking server 106 may determine the association of the user 112a with the user 112b based on the one or more parameters. The association may be based on one or more parameters that are well known to those skilled in the art. Some examples of the one or more parameters may include, but are not limited to, an area of interest, an activity of interest, an event, an educational background, a professional background, a relation, or a social network connection. Notwithstanding, the disclosure may not be so limited, and other parameters may be utilized without limiting the scope of the disclosure.

In an embodiment, the computing device 108a may receive a verification from the social networking server 106 as to whether the user 112a is associated with the user 112b in the social network 114 based on the user identification data of the user 112a.

In an embodiment, the social networking server 106 may respond to the authentication server 102 with the result of the authentication of the determined user identification data. In instances where the association of the user 112a with the user 112b based on the one or more parameters is not authenticated, the authentication server 102 may deny the user 112a, access to the computing device 108a. In an embodiment, the computing device 108a may deny the access to user 112a. Accordingly, the user 112a may be unable to participate in the event in association with the user 112b. In instances where the association of the user 112a with the user 112b based on the one or more parameters is successfully authenticated, the authentication server 102 may authenticate the user 112a to access the computing device 108a. In an embodiment, the computing device 108a may authenticate the user 112a to access the computing device 108a.

In an embodiment, the social networking server 106 may respond to the computing device 108a with the result of the authentication of the determined user identification data. In instances where the association of the user 112a with the user 112b based on the one or more parameters is not authenticated, the computing device 108a may deny access to the user 112a. Accordingly, the user 112a may be unable to participate in the event in association with the user 112b. In instances where the association of the user 112a with the 112b based on the one or more parameters is successfully authenticated, the computing device 108a may authenticate the user 112a to access the computing device 108a.

Once authenticated, the user 112a associated with the computing device 108a may participate in the event in association with the user 112b, for example, communicate with the user 112b, access an online event, access online or offline information, join an online conference, share or receive an electronic file or access a restricted application. The online event may include, but is not limited to, a meeting, a conference, a multi-player game, a video session or a chat session in the social network. Notwithstanding, the disclosure may not be so limited, and other online events may be considered without limiting the scope of the disclosure. In an embodiment, the authenticated user 112a may enable the user 112a to personalize the login screen and/or change the user interface of the associated computing device 108a.

In an embodiment, the repository that includes the one or more pre-specified passphrases and/or the master-set of tones may be stored in the database 104 communicably coupled to the authentication server 102. In an embodiment, the repository that includes the one or more pre-specified passphrases and/or the master set of tones may be stored in the memory 204 of the authentication server 102. In an embodiment, the repository that includes the one or more pre-specified passphrases and/or the master set of tones may be stored in the memory 304. Notwithstanding, the disclosure may not be so limited, and other devices/servers may be utilized to store the repository without limiting the scope of the disclosure.

FIG. 2 is a block diagram illustrating an authentication server for user authentication, in accordance with an embodiment of the disclosure. FIG. 2 is explained in conjunction with elements from FIG. 1. With reference to FIG. 2, there is shown the authentication server 102. The authentication server 102 may include one or more processors, such as a processor 202, a memory 204, and a transceiver 208.

The processor 202 may be communicatively coupled to the memory 204. Further, the transceiver 208 may be communicatively coupled to the processor 202, and the memory 204.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a Reduced Instruction Set Computing (RISC) processor, an Application-Specific Integrated Circuit (ASIC) processor, a Complex Instruction Set Computing (CISC) processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a Secure Digital (SD) card.

The transceiver 208 may comprise suitable logic, circuitry, interfaces, and/or code that may be operable to communicate with the authentication server 102 and the social networking server 106 via different communication interfaces. The transceiver 208 may implement known technologies for supporting wired or wireless communication with the communication network 110. The transceiver 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 208 may communicate via wireless communication with networks, such as the Internet, an Intranet and/or a wireless network, such as a cellular telephone network, a wireless local area network (LAN) and/or a metropolitan area network (MAN), and other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 202 in the authentication server 102 may determine one or more rules for participating in an event. The one or more rules may define an association between the user 112b and the user 112a participating in the event. The one or more rules may include one or more pre-specified passphrases, a master set of tones, a threshold associated with the comparison of user identification data of the user 112a with pre-stored user identification data. In an embodiment, the processor 202 in the authentication server 102 may communicate an invite to the user 112a participating in the event.

In an embodiment, the processor 202 in the authentication server 102 may receive an audio input from the computing device 108a via the transceiver 208 in the authentication server 102. In response to the audio input, the processor 202 in the authentication server 102 may determine a user identification data from the received audio input.

In an embodiment, the processor 202 in the authentication server 102 may determine the passphrase by applying one or more voice recognition algorithms to the received audio input. In an embodiment, the processor 202 in the authentication server 102 may determine the passphrase by applying one or more speech-to-text conversion software applications. In an embodiment, the processor 202 in the authentication server 102 further determines a set of tones from the received audio input.

In an embodiment, the processor 202 in the authentication server 102 may compare the passphrase and/or the set of tones determined from the received audio input, with one or more pre-specified passphrases and/or a master set of tones pre-stored in the repository. In an embodiment, the repository may be stored in the memory 204 of the authentication server 102. In an embodiment, the repository may be stored in the database 104 that is communicably coupled to the authentication server 102 via the transceiver 208.

In instances, where the passphrase and/or the set of tones does not match the one or more pre-specified passphrases and/or the master set of tones in the repository, the processor 202 in the authentication server 102 may deny the user 112a, access to the computing device 108a. Accordingly, the user 112a may be unable to participate in the event in association with the user 112b. In instances, where the passphrase and/or the set of tones successfully matches the one or more pre-specified passphrases and/or the master set of tones in the repository, the authentication server 102 may determine the user identification data associated with the user 112a based on the received audio input. The processor 202 in the authentication server 102 may receive the verification from the social networking server 106 as to whether the user 112a is associated with the one or more other users, for example the user 112b, in the social network 114. The processor 202 in the authentication server 102 may determine the association of the user 112a with the user 112b based on comparison of the determined user identification data with the pre-stored user identification data. In an embodiment, the processor 202 in the authentication server 102 may determine the association of the user 112a with the user 112b based on the one or more rules. In an embodiment, the processor of the authentication server 102 may not determine an association of the user 112a with one or more users, for example the user 112c based on comparison of the determined user identification data with the pre-stored user identification data.

In an embodiment, the processor 202 in the authentication server 102 may receive the verification from the social networking server 106 as to whether the user 112a is associated with the user 112b in the social network 114 based on the user identification data of the user 112a. The social networking server 106 may determine the association of the user 112a with the user 112b, based on one or more parameters.

In an embodiment, the social networking server 106 may respond to the processor 202 in the authentication server 102 with the result of the authentication of the determined user identification data. In instances where the association of the user 112a with the user 112b based on the one or more parameters is not authenticated, the processor 202 in the authentication server 102 may deny the user 112a, access to the computing device 108a. Accordingly, the user 112a may be unable to participate in the event in association with the user 112b. In instances where the association of the user 112a with the user 112b based on the one or more parameters is successfully authenticated, processor 202 in the authentication server 102 may authenticate the user 112a to access the computing device 108a. Once authenticated, the user 112a associated with the computing device 108a may participate in the event in association with the user 112b.

FIG. 3 is a block diagram illustrating a computing device for user authentication, in accordance with an embodiment of the disclosure. FIG. 3 is explained in conjunction with elements from FIG. 1. With reference to FIG. 3, there is shown the computing device 108. The computing device 108 may include one or more processors, such as a processor 302, a memory 304, one or more Input-Output (I/O) devices, such as an I/O device 306, and a transceiver 308.

The processor 302 may be communicatively coupled to the memory 304, and the I/O device 306. Further, the transceiver 308 may be communicatively coupled to the processor 302, the memory 304, and the I/O device 306.

The processor 302 may comprise suitable logic, circuitry, interfaces, and/or code that may be operable to execute a set of instructions stored in the memory 304. The processor 302 may be implemented based on a number of processor technologies known in the art. Examples of processor 302 may be an X86-based processor, a Reduced Instruction Set Computing (RISC) processor, an Application-Specific Integrated Circuit (ASIC) processor, a Complex Instruction Set Computing (CISC) processor, or any other processor.

The memory 304 may comprise suitable logic, circuitry, interfaces, and/or code that may be operable to store the received set of instructions. The memory 304 may be implemented based on, but not limited to, a Random Access Memory (RAM), a Read-Only Memory (ROM), a Hard Disk Drive (HDD), a storage server and/or a Secure Digital (SD) card.

The I/O device 306 may comprise various input and output devices operably connected to the processor 302. Examples of the input devices may include, but are not limited to, a keyboard, a mouse, a joystick, a touch screen, a microphone, a camera, a motion sensor, a light sensor, and/or a docking station. Examples of the output devices may include, but are not limited to, a display and a speaker.

The transceiver 308 may comprise suitable logic, circuitry, interfaces, and/or code that may be operable to communicate with the authentication server 102 and the social networking server 106 via different communication interfaces. The transceiver 308 may implement known technologies for supporting wired or wireless communication with the communication network 110. The transceiver 308 may include, but is not limited to, an antenna, an radio frequency (RF) transceiver, one or more amplifiers, a tuner, one or more oscillators, a digital signal processor, a coder-decoder (CODEC) chipset, a subscriber identity module (SIM) card, and/or a memory. The transceiver 308 may communicate via wireless communication with networks, such as the Internet, an Intranet and/or a wireless network, such as a cellular telephone network, a wireless local area network (LAN) and/or a metropolitan area network (MAN), and other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 302 in the computing device 108a may receive an audio input from the user 112a via the I/O device 306. In response to the audio input, the processor 302 in the computing device 108a may determine user identification data associated with the user 112a based on the received audio input. In an embodiment, the processor 302 in the computing device 108a may determine a passphrase from the received audio input. In an embodiment, the processor 302 in the computing device 108a may determine the passphrase by applying one or more voice recognition algorithms to the received audio input. In an embodiment, the processor 302 in the computing device 108a may determine the passphrase by applying speech-to-text conversion software applications to the received audio input.

In an embodiment, the processor 302 in the computing device 108a may determine a set of tones from the audio input. In an embodiment, the set of tones may be generated manually by the user 112a of the computing device 108a. In an embodiment, the set of tones may be automatically generated by a multimedia application associated with the computing device 108a.

In an embodiment, the passphrase and/or the set of tones may be determined by the user 112a or the user 112b. In an embodiment, the passphrase and/or the set of tones may be same for the user 112a or the user 112b. In an embodiment, the passphrase and/or the set of tones may be different for the user 112a or the user 112b.

In an embodiment, the processor 302 in the computing device 108a may compare the passphrase and/or the set of tones determined from the received audio input, with one or more pre-specified passphrases and/or a master set of tones pre-stored in the repository. In an embodiment, the repository that includes the one or more pre-specified passphrases and/or the master set of tones may be stored in the memory 304 of the computing device 108a. In an embodiment, the repository may be stored in the memory 204 of the authentication server 102 or the database 104. In such cases, the processor 302 in the computing device 108a may access the repository using the transceiver 308 via the communication network 110.

In an embodiment, the processor 302 in the computing device 108a may compare the passphrase and/or the set of tones determined from the received audio input, with one or more pre-specified passphrases and/or a master set of tones pre-stored in the repository.

In instances where the passphrase and/or the set of tones does not match the one or more pre-specified passphrases and/or the master set of tones in the repository, the processor 302 in the computing device 108a may deny the user 112a, access to the computing device 108a. Accordingly, the user 112a may be unable to participate in the event in association with the user 112b. In instances, where the passphrase and/or the set of tones successfully matches the one or more pre-specified passphrases and/or the master set of tones in the repository, the processor 302 in the computing device 108a may determine the user identification data associated with the user 112a based on the received audio input. The processor 302 in the computing device 108a may determine whether the user 112a is associated with one or more other users, for example, the user 112b, in the social network 114. The processor 302 in the computing device 108a may determine the association of the user 112a with the user 112b based on comparison of the determined user identification data with the pre-stored user identification data. In an embodiment, the processor 302 in the authentication server 102 may not determine an association of the user 112a with one or more users, for example, the user 112c based on comparison of the determined user identification data with the pre-stored user identification data. In an embodiment, the pre-stored user identification data may be stored in the social networking server 106 and the processor 302 in the computing device 108a communicates with the social networking server 106 using the transceiver 308 via the communication network 110.

In an embodiment, the processor 302 in the computing device 108a may receive the verification from the social networking server 106 as to whether the user 112a is associated with the user 112b in the social network 114 based on the user identification data of the user 112a. The social networking server 106 determines the association of the user 112a with the user 112b based on one or more parameters. The one or more parameters may be similar for both the user 112a and the user 112b based on whether the user 112a and the user 112b belong to the social network 114 in the communication network 110.

In an embodiment, the processor 302 in the computing device 108a may receive the verification from the social networking server 106 as to whether the user 112a is associated with the user 112b in the social network 114 based on the user identification data of the user 112a.

In an embodiment, the social networking server 106 may respond to the processor 302 in the computing device 108a with the result of the authentication of the determined user identification data. In instances where the association of the user 112a with the user 112b based on one or more parameters is not authenticated, the processor 302 in the computing device 108a may deny the user 112a, access to the computing device 108a. Accordingly, the user 112a may be unable to participate in the event in association with the user 112b. In instances where the association of the user 112a with the user 112b based on one or more parameters is successfully authenticated, the processor 302 in the computing device 108a may authenticate the user 112a to access the computing device 108a.

Once authenticated, the processor 302 in the computing device 108a allows the user 112a associated with the computing device 108a to participate in the event in association with the user 112b. In an embodiment, the processor 302 in the computing device 108a may enable the user 112a to personalize the login screen and/or change the user interface of the associated computing device 108a.

FIG. 4 is a flowchart illustrating a method for user authentication, in accordance with an embodiment of the disclosure. FIG. 4 is described in conjunction with elements of FIG. 1. The method 400 may be implemented in the authentication server 102, communicatively coupled to the database 104, the social networking server 106 and computing device 108 via the communication network 110.

The method 400 begins at step 402 and proceeds to step 404. At step 404, the authentication server 102 may determine one or more rules for participating in an event. The one or more rules may define an association between user 112b and the user 112a participating in the event. The one or more rules may include one or more pre-specified passphrases, a master set of tones, a threshold associated with the comparison of user identification data of the user 112a with pre-stored user identification data. In an embodiment, the authentication server 102 may communicate an invite to the user 112a participating in the event.

At step 406, the authentication server 102 may receive an audio input from the computing device 108a associated with the user 112a. At step 408, in response to the audio input, the authentication server 102 may determine user identification data associated with the user 112a based on the received audio input. In an embodiment, the authentication server 102 may determine the passphrase by applying one or more voice recognition algorithms to the received audio input.

In an embodiment, the authentication server 102 may determine the passphrase by applying one or more speech-to-text conversion software applications. In an embodiment, the authentication server 102 further determines a set of tones from the received audio input.

In an embodiment, the authentication server 102 may compare the passphrase and/or the set of tones determined from the received audio input, with one or more pre-specified passphrases and/or a master set of tones pre-stored in the repository. In an embodiment, the repository may be stored in the memory 204 of the authentication server 102. In an embodiment, the repository may be stored in the database 104 that is communicably coupled to the authentication server 102.

In instances, where the passphrase and/or the set of tones does not match the one or more pre-specified passphrases and/or the master set of tones in the repository, the authentication server 102 may deny the user 112a, access to the computing device 108a. Accordingly, the user 112a may be unable to participate in the event in association with the user 112b.

In instances, where the passphrase and/or the set of tones successfully match with the one or more pre-specified passphrases and/or the master set of tones in the repository, the method proceeds to step 410.

At step 410, the authentication server 102 may determine whether the user 112a is associated with a user 112b in the social network 114 based on comparison of the user identification data of the user 112a with pre-stored user identification data. In an embodiment, the authentication server 102 may access the social networking server 106 to determine whether the user 112a is associated with the user 112b in the social network 114.

In instances where the user 112a is not associated with the user 112b based on the comparison of the user identification data of the user 112a with pre-stored user identification data, the method proceeds to step 416. At step 416, the authentication server 102 may deny the user 112a, access to the computing device 108a. Accordingly, the user 112a may be unable to participate in the event in association with the user 112b. Control then passes to end step 414.

In instances where the user 112a is associated with the user 112b based on the comparison of the user identification data of the user 112a with pre-stored user identification data, the method proceeds to step 412. At step 412, the authentication server 102 may authenticate the user 112a based on the comparison performed at the step 410 and the one or more rules determined at step 404. Once authenticated, the user 112a may access the computing device 108a. The user 112a may participate in the event in association with the user 112b. Control then passes to end step 414.

FIG. 5 is a flowchart illustrating a method for user authentication, in accordance with an embodiment of the disclosure. FIG. 5 is described in conjunction with elements of FIG. 1. The method 500 may be implemented in the authentication server 102, communicatively coupled to the database 104, the social networking server 106 and computing device 108 via the communication network 110.

The method 500 begins at step 502 and proceeds to step 504. At step 504, the authentication server 102 may receive an audio input from the computing device 108a associated with the user 112a. At step 506, in response to the received audio input, the authentication server 102 may determine user identification data associated with the user 112a.

In an embodiment, the authentication server 102 may determine a passphrase by applying one or more voice recognition algorithms to the received audio input. In an embodiment, the authentication server 102 may determine the passphrase by applying one or more speech-to-text conversion software applications. In an embodiment, the authentication server 102 further determines a set of tones from the received audio input.

In an embodiment, the authentication server 102 may compare the passphrase and/or the set of tones determined from the received audio input, with one or more pre-specified passphrases and/or a master set of tones pre-stored in the repository. In an embodiment, the repository may be stored in the memory 204 of the authentication server 102. In an embodiment, the repository may be stored in the database 104 that is communicably coupled to the authentication server 102.

In instances, where the passphrase and/or the set of tones does not match the one or more pre-specified passphrases and/or the master set of tones in the repository, the authentication server 102 may deny the user 112a, access to the computing device 108a. Accordingly, the user 112a may be unable to participate in the event in association with the user 112b.

In instances, where the passphrase and/or the set of tones successfully match with the one or more pre-specified passphrases and/or the master set of tones in the repository, the method proceeds to step 508.

At step 508, the authentication server 102 may determine whether the user 112a is associated with a user 112b in the social network 114 based on comparison of the user identification data of the user 112a with pre-stored user identification data. In an embodiment, the authentication server 102 may access the social networking server 106 to determine whether the user 112a is associated with the user 112b in the social network 114.

In instances where the user 112a is not associated with the user 112b based on comparison of the user identification data of the user 112a with pre-stored user identification data, the method proceeds to step 514.

At step 514, the authentication server 102 may deny the user 112a, access to the computing device 108a. Accordingly, the user 112a may be unable to participate in the event in association with the user 112b. Control then passes to end step 512.

In instances where the user 112a is associated with the user 112b based on comparison of the user identification data of the user 112a with pre-stored user identification data, the method proceeds to step 510.

At step 510, the authentication server 102 may authenticate the user 112a. Once authenticated, the user 112a may access the computing device 108a. The user 112a may participate in the event in association with the user 112b. Control then passes to end step 512.

FIG. 6 is a flowchart illustrating another method for user authentication, in accordance with an embodiment of the disclosure. FIG. 6 is described in conjunction with elements of FIG. 1. The method 600 may be implemented in the computing device 108a, communicatively coupled to the authentication server 102, the database 104, and the social networking server 106 via the communication network 110.

The method 600 begins at step 602 and proceeds to step 604. At step 604, the computing device 108a may receive an audio input from a user 112a associated with the computing device 108a.

At step 606, in response to the audio input, the computing device 108a may determine user identification data associated with the user 112a based on the received audio input. In an embodiment, the computing device 108a may determine a passphrase by applying one or more voice recognition algorithms to the received audio input. In an embodiment, the computing device 108a may determine the passphrase by applying one or more speech-to-text conversion software applications. In an embodiment, the computing device 108a further determines a set of tones from the received audio input.

In an embodiment, the computing device 108a may compare the passphrase and/or the set of tones determined from the received audio input, with one or more pre-specified passphrases and/or a master set of tones pre-stored in the repository. In an embodiment, the repository may be stored in the memory 204 of the computing device 108a. In an embodiment, the repository may be stored in the database 104 that is communicably coupled to the authentication server 102 and may be accessed by the computing device 108a via the communication network 110.

In instances where the passphrase and/or the set of tones does not match the one or more pre-specified passphrases and/or the master set of tones in the repository, the computing device 108a may deny the user 112a, access to the computing device 108a. Accordingly, the user 112a may be unable to participate in the event in association with the user 112b.

In instances where the passphrase and/or the set of tones successfully match with the one or more pre-specified passphrases and/or the master set of tones in the repository, the method proceeds to step 608.

At step 608, the computing device 108a may determine whether the user 112a is associated with a user 112b in the social network 114 based on comparison of the user identification data of the user 112a with pre-stored user identification data. In an embodiment, the computing device 108a may access the social networking server 106 to determine whether the user 112a is associated with the user 112b in the social network 114.

In instances where the user 112a is associated with the user 112b based on comparison of the user identification data of the user 112a with pre-stored user identification data, the method proceeds to step 614.

At step 614, the computing device 108a may deny the user 112a, access to the computing device 108a. Accordingly, the user 112a may be unable to participate in the event in association with the user 112b. Control then passes to end step 612.

In instances where the user 112a is not associated with the user 112b based on comparison of the user identification data of the user 112a with pre-stored user identification data, the method proceeds to step 610.

At step 610, the computing device 108a may authenticate the user 112a. Once authenticated, the user 112a may access the computing device 108a. The user 112a may participate in the event in association with the user 112b. The authenticated user 112a may personalize a login screen and/or change a user interface of the computing device 108a. Control then passes to end step 612.

In accordance with an embodiment of the disclosure, a system and method for user authentication may include one or more processors and/or circuits. Exemplary aspects of the disclosure may include the one or more processors and/or circuits in the authentication server 102. The one or more processors and/or circuits may be operable to determine one or more rules for participating in an event. The one or more rules may define an association between the user 112b and one or more other users participating in the event. The one or more processors and/or circuits may be operable to receive an audio input from the user 112a. The one or more processors and/or circuits may be operable to determine user identification data associated with the user 112a based on the received audio input. The one or more processors and/or circuits may be operable to determine whether the user 112a is associated with the user 112b based on comparison of the determined user identification data with pre-stored user identification data. The one or more processors and/or circuits may be operable to authenticate the user 112a to participate in the event based on the comparison and the one or more rules.

In an embodiment, the one or more processors and/or circuits may be operable to communicate an invite to the one or more other users participating in the event. In an embodiment, the one or more rules may include one or more pre-specified passphrases, a master set of tones, a threshold associated with the comparison of the determined user identification data with pre-stored user identification data. In an embodiment, the association of the user 112b with the one or more other users in the social network is based on one or more parameters. The one or more parameters may comprise an area of interest, an activity of interest, an event, an educational background, a professional background, a relation, or a social network connection.

In accordance with an embodiment of the disclosure, a system and method for user authentication may include one or more processors and/or circuits. Exemplary aspects of the disclosure may include the one or more processors and/or circuits in the authentication server 102. The one or more processors and/or circuits may be operable to receive an audio input from the computing device 108a associated with the user 112a. The one or more processors and/or circuits may be operable to determine user identification data associated with the user 112a based on the received audio input. The one or more processors and/or circuits may be operable to determine whether the user 112a is associated with the user 112b in the social network 114 based on comparison of the determined user identification data with pre-stored user identification data stored in the social networking server 106. The one or more processors and/or circuits may be operable to authenticate the user 112a to participate in an event in association with the user 112b based on the comparison.

In an embodiment, the one or more processors and/or circuits may be operable to determine a passphrase from the received audio input based on one or more voice recognition algorithms or one or more speech-to-text conversion software applications.

In an embodiment, the one or more processors and/or circuits may be operable to compare the determined passphrase with one or more pre-specified passphrases. In an embodiment, the one or more pre-specified passphrases may be determined by the user 112a. In an embodiment, the one or more pre-specified passphrases may be determined by the user 112b. In an embodiment, the one or more processors and/or circuits may be operable to authenticate the user 112a based on the comparison of the determined passphrase with one or more pre-specified passphrases. In an embodiment, the one or more pre-specified passphrases may be same for the user 112a and the user 112b. In another embodiment, the one or more pre-specified passphrases may be different for the user 112a and the user 112b.

In an embodiment, the received audio input may include a set of tones. The set of tones may be generated by a multimedia application associated with the computing device 108a. In an embodiment, the one or more processors and/or circuits may be operable to compare the received set of tones with a master set of tones. In an embodiment, the master set of tones may be defined by the user 112a or the user 112b.

In an embodiment, the user identification data may include a user profile of the user 112a associated with the computing device 108a. In an embodiment, the user profile associated with the user 112a may include a geographical location of the user 112a, a facial image of the user 112a or demographic details of the user 112a. In an embodiment, the pre-stored user identification data may include one or more user profiles associated with the user 112a and the user 112b.

In an embodiment, the event may include communication of the user 112a with the user 112b, accessing an online event, accessing online or offline information, joining an online conference, sharing or receiving an electronic file or accessing a restricted application. In an embodiment, the online event may include a meeting, a conference, a multi-player game, a video session or a chat session in the social network 114.

In an embodiment, the association of the user 112a with the user 112b in the social network 114 may be based on one or more parameters between the user 112a and the user 112b. In an embodiment, the one or more parameters between the user and the one or more other users may include one or more of an area of interest, an activity of interest, an event, an educational background, a professional background, a relation, or a social network connection.

In accordance with an embodiment of the disclosure, a system and method for user authentication may include one or more processors and/or circuits. Exemplary aspects of the disclosure may include the one or more processors and/or circuits in the computing device 108a. The one or more processors and/or circuits may be operable to receive an audio input from the user 112a. The one or more processors and/or circuits may be operable to determine user identification data associated with the user 112a based on the received audio input. The one or more processors and/or circuits may be operable to determine whether the user 112a is associated with the user 112b in the communication network 110 based on comparison of the determined user identification data with pre-stored user identification data. The one or more processors and/or circuits may be operable to authenticate the user 112a to participate in the event in association with the user 112b based on the comparison of the determined user identification data with pre-stored user identification data.

In an embodiment, the one or more processors and/or circuits may be operable to may personalize a login screen of the computing device 108a by the user 112a based on the authentication. In an embodiment, the one or more processors and/or circuits may be operable to change a user interface of the computing device 108a by the user 112a based on the authentication.

Other embodiments of the disclosure may provide a non-transitory computer readable medium, and/or storage medium, and/or a non-transitory machine-readable medium and/or storage medium. Having applicable mediums stored thereon, a machine code and/or a computer program having at least one code section executable by a machine and/or a computer, may thereby cause the machine and/or computer to perform the steps comprising determining one or more rules for participating in an event receiving an audio input from a second user, determining user identification data associated with the second user based on the received audio input, determining whether the second user is associated with the first user based on comparison of the determined user identification data with pre-stored user identification data, and authenticating the second user to participate in the event based on the comparison and the one or more rules.

Other embodiments of the disclosure may provide a non-transitory computer readable medium, and/or storage medium, and/or a non-transitory machine-readable medium and/or storage medium. Having applicable mediums stored thereon, a machine code and/or a computer program having at least one code section executable by a machine and/or a computer, may thereby cause the machine and/or computer to perform the steps comprising receiving an audio input from one of the plurality of computing devices associated with a user, determining user identification data associated with the user based on the received audio input, determining whether the user is associated with one or more other users in the social network based on comparison of the determined user identification data with pre-stored user identification data, and authenticating the user to participate in the event in association with the one or more other users based on the comparison.

Other embodiments of the disclosure may provide a non-transitory computer readable medium, and/or storage medium, and/or a non-transitory machine-readable medium and/or storage medium. Having applicable mediums stored thereon, a machine code and/or a computer program having at least one code section executable by a machine and/or a computer, may thereby cause the machine and/or computer to perform the steps for receiving an audio input from a user, determining user identification data associated with the user based on the received audio input, determining whether the user is associated with one or more other users in the social network based on comparison of the determined user identification data with pre-stored user identification data, and authenticating the user to participate in the event in association with the one or more other users based on the comparison.

Accordingly, the present disclosure may be realized in hardware, or a combination of hardware and software. The present disclosure may be realized in a centralized fashion, in at least one computer system, or in a distributed fashion, where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that includes a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for user authentication, said system comprising:
in a communication network comprising a server communicably coupled to a plurality of computing devices, one or more processors in said server being operable to:
determine one or more rules for participating in an event, wherein said one or more rules define an association between a first user and one or more other users participating in said event;
receive an audio input from a second user;
determine user identification data associated with said second user based on said received audio input;
determine whether said second user is associated with said first user based on comparison of said determined user identification data with pre-stored user identification data; and
authenticate said second user to participate in said event based on said comparison and said one or more rules.

2. The system of claim 1, wherein said one or more processors are operable to communicate an invite to said one or more other users participating in said event.

3. The system of claim 1, wherein said one or more rules comprise one or more pre-specified passphrases, a master set of tones, a threshold associated with said comparison of said determined user identification data with pre-stored user identification data.

4. The system of claim 1, wherein said association of said first user with said one or more other users is based on one or more parameters.

5. The system of claim 4, wherein said one or more parameters comprise one or more of: an area of interest, an activity of interest, an event, an educational background, a professional background, a relation, or a social network connection.

6. A system for user authentication, said system comprising:
in a communication network comprising a server communicably coupled to a plurality, of computing devices, one or more processors in said server being operable to:
receive an audio input from one of said plurality of computing devices associated with a user;
determine user identification data associated with said user based on said received audio input;
determine whether said user is associated with one or more other users in a social network based on comparison of said determined user identification data with pre-stored user identification data, wherein said social network is at least a part of said communication network; and
authenticate said user to participate in an event in association with said one or more other users based on said comparison.

7. The system of claim 6, wherein said one or more processors are operable to determine a passphrase from said received audio input based on one or both of a voice recognition algorithm and/or a speech-to-text conversion software application.

8. The system of claim 7, wherein said one or more processors are operable to compare said passphrase with one or more pre-specified passphrases, wherein said one or more pre-specified passphrases are assigned by said user or said one or more other users.

9. The system of claim 8, wherein said one or more processors are operable to authenticate said user based on said comparison of said passphrase with said one or more pre-specified passphrases.

10. The system of claim 8, wherein said one or more pre-specified passphrases are same for said user and said one or more other users.

11. The system of claim 8, wherein said one or more pre-specified passphrases are different for said user and said one or more other users.

12. The system of claim 6, wherein said received audio input comprises a set of tones, wherein said one or more processors are operable to compare said set of tones with a master set of tones, wherein said master set of tones is defined by said user or said one or more other users.

13. The system of claim 12, wherein said set of tones is automatically generated by a multimedia application associated with one of said plurality of computing devices.

14. The system of claim 6, wherein said user identification data comprises a user profile of said user associated with said one of said plurality of computing devices.

15. The system of claim 14, wherein said user profile associated with said user comprises one or more of: a geographical location of said user, a facial image of said user or demographic details of said user.

16. The system of claim 6, wherein said pre-stored user identification data comprises one or more user profiles associated with said user and said one or more other users.

17. The system of claim 6, wherein said event comprises one or more of: communication of said user with said one or more other users, accessing an online event, accessing online or offline information, joining an online conference, sharing or receiving an electronic file or accessing a restricted application.

18. The system of claim 17, wherein said online event comprises one or more of: a meeting, a conference, a multi-player game, a video session or a chat session in said social network.

19. The system of claim 6, wherein said association of said user with said one or more other users in said social network is based on one or more parameters.

20. The system of claim 19, wherein said one or more parameters comprises one or more of: an area of interest, an activity of interest, an event, an educational background, a professional background, a relation, or a social network connection.

21. A system for user authentication, said system comprising:
in a communication network comprising a server communicably coupled to a plurality of computing devices, one or more processors in said computing device being operable to:
receive an audio input from a user;
determine user identification data associated with said user based on said received audio input;
determine whether said user is associated with one or more other users in a social network based on comparison of said determined user identification data with pre-stored user identification data, wherein said social network is at least a part of said communication network; and
authenticate said user to participate in an event in association with said one or more other users based on said comparison.

22. The system of claim 21, wherein said one or more processors are operable to personalize a login screen and/or change a user interface based on said authentication of said user.

23. A method for user authentication, said method comprising:
in a communication network comprising a server communicably coupled to a plurality of computing devices:
receiving an audio input from one of said plurality of computing devices associated with a user;
determining user identification data associated with said user based on said received audio input;
determining whether said user is associated with one or more other users in a social network based on comparison of said determined user identification data with pre-stored user identification data, wherein said social network is at least a part of said communication network; and
authenticating said user to participate in an event in association with said one or more other users based on said comparison.

24. The method of claim 23, comprising determining a passphrase from said received audio input based on one or both of a voice recognition algorithm and/or a speech-to-text conversion software application.

25. The method of claim 24, comprising comparing said passphrase with one or more pre-specified passphrases, wherein said one or more pre-specified passphrases are determined by said user or said one or more other users.

26. The method of claim 23, comprising authenticating said user based on said comparison of said passphrase with said one or more pre-specified passphrases.

27. The method of claim 25, wherein said one or more pre-specified passphrases are same for said user and said one or more other users.

28. The method of claim 25, wherein said one or more pre-specified passphrases are different for said user and said one or more other users.
